(19) United States
(12) Patent Application Publication
(10) Pub. No.: US 2026/0220123 A1
(43) Pub. Date: Jul. 30, 2026

(54) Entity Resolution Based on Population Statistics

(71) Applicant: Senzing, Inc., Las Vegas, NV (US)

(72) Inventors: Jeffrey James Jonas, Las Vegas, NV (US); Brian Eugene Macy, Lovettsville, VA (US)

(21) Appl. No.: 19/447,248

(22) Filed: Jan. 13, 2026

Related U.S. Application Data
(60) Provisional application No. 63/750,955, filed on Jan. 29, 2025.

(51) Int. Cl. G06F 16/23

(52) U.S. Cl. CPC G06F 16/2365

(57) ABSTRACT

Population statistics are received. Real-time statistics for attributes are maintained as records are processed. An incoming data record with attributes is received. Whether a category associated with the incoming data record has reached an enumeration threshold is determined based on the population statistics. An attribute importance of an attribute of the incoming data record is determined based on a distinctiveness of the attribute within the category associated with the incoming data record. The distinctiveness is determined based on the maintained real-time statistics for the attribute in response to determining that the category has reached the enumeration threshold. The incoming data record is then resolved to existing entities based on the attribute importance.

### CROSS REFERENCE TO RELATED APPLICATIONS

This application claims the benefit of and priority to U.S. Provisional Patent Application Serial No. 63/750,955, filed January 29, 2025, the entire disclosure of which is incorporated herein by reference.

### TECHNICAL FIELD

This disclosure relates generally to entity resolution, and more specifically to entity resolution through real-time updating of categorized population statistics.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 illustrates an example of a block diagram of a system for performing entity resolution using effectively enumerated populations.

FIG. 2 is a block diagram illustrating an example internal configuration of a computing device.

FIGS. 3A-3E illustrate an example of entity resolution using population statistics and effectively enumerated populations.

FIG. 4 is a block diagram of an entity resolution software.

FIG. 5 is a flowchart of an example of a technique for entity resolution using effectively enumerated populations.

FIG. 6 is a flowchart of an example of a technique for entity resolution using effectively enumerated populations.

### DETAILED DESCRIPTION

Entity resolution refers to the process of identifying, matching, and merging records that correspond to the same entity across different datasets. More specifically, entity resolution involves finding records in a dataset that refer to the same entity or entities with similarities within or across various data sources. This technique is advantageous in scenarios where data might be inconsistent, incomplete, or duplicated. For example, entity resolution may identify and combine records for ‘John Smith’ and ‘J. Smith’ as referring to the same entity (e.g., individual), even if certain attributes, such as address or phone number, differ. Through successive matching and merging operations, additional records contribute new information that enriches the understanding of each entity. This cumulative process enables progressive construction of a more complete and accurate representation of the tracked entities, whether they are people, businesses, or objects, thereby enhancing decision-making capabilities based on the resolved entities.

As used herein, “effectively enumerated” refers to a state in which a category or sub-category has reached a configurable threshold of population coverage sufficient for the entity resolution software to make statistically meaningful determinations about attribute distinctiveness within that category. Effective enumeration does not require complete or exhaustive population coverage; rather, it represents a sufficient proportion of coverage, which may be configured based on the certainty requirements of a particular application. For example, a category may be considered effectively enumerated when 70%, 80%, 95%, or another configurable percentage of the expected population has been identified, depending on the statistical reliability requirements of the system.

As used herein, “resolving” an incoming data record, and related terms such as “resolution” and “entity resolution operation,” refers to the complete process of determining the disposition of the incoming data record with respect to entity data. This includes associating the incoming data record with an existing entity when a match is identified, creating a new entity when no sufficient match to an existing entity is found, establishing relationships (e.g., “same,” “possibly same,” or “related”) between entities, and updating statistics and entity data based on the resolution outcome. Accordingly, resolving an incoming data record to existing entities encompasses performing any entity resolution operation on the incoming data record, whether or not that operation results in a match to a pre-existing entity.

Implementations according to this disclosure enhance entity resolution through real-time maintenance of categorized statistics and dynamic population enumeration, where “effectively enumerated” refers to a state where a known or substantially complete set of entities within a specific category has been identified and processed. Entity resolution software maintains and updates statistics about attribute occurrences within categories (e.g., names by city, county, or region), which may be hierarchical, in real-time as records are processed. These statistics enable the entity resolution software to determine when a category or sub-category becomes effectively enumerated based on statistical thresholds or user-provided information about population sizes. For example, a category becomes effectively enumerated when the number of unique entities processed (e.g., identified) reaches a sufficient proportion of a known population count for that category, such as when the number of processed adult residents in a city approaches the city’s known adult population.

A population may become effectively enumerated over time as the entity resolution software continuously ingests new data or incorporates datasets. The enumeration status evolves dynamically, meaning that an entity set that may begin with partial coverage can reach an enumeration threshold as new records are added. For example, a city-level population of identified entities may begin with incomplete data (e.g., 10% of residents recorded) but become effectively enumerated (e.g., reaching the configured threshold) after additional records are processed. To illustrate, if input to the entity resolution software indicates that SmallTown of SmallCounty has a population of 10,000 adults and the software detects matching records for a sufficient number of distinct individuals (i.e., entities), the town-level category can be marked as effectively enumerated. In contrast, the software may recognize that SmallCounty, which contains SmallTown, is not effectively enumerated if only 330,000 out of 450,000 people (e.g., the population statistic of SmallCounty) have been identified. This hierarchical approach enables selective enumeration, ensuring precise control over which datasets or categories (e.g., geographic regions) are considered sufficiently covered. Once a population is recognized as effectively enumerated, previously processed records can be automatically re-evaluated to determine whether any updates to attribute weights or match decisions are warranted. This process ensures that high accuracy is maintained by leveraging the most current population statistics available.

A population does not need to be completely enumerated to affect the entity resolution process. Attribute importance or behavior (e.g., feature weighting) can be dynamically adjusted based on the degree of population coverage, with certainty increasing as more data is acquired. For instance, while a name like “John Smith” is typically treated as a weak identifier, the system can increase its importance if the effectively enumerated dataset confirms that a low number (e.g., only one) of “John Smith” entities is expected to exist within a specific, effectively enumerated region, such as Mumbai, India. This capability ensures that matching decisions reflect the context and distinctiveness of data attributes.

Stated another way, the name attribute (e.g., a person’s name) is generally considered a weak identifier for matching because many people may share the same name. However, assume that an entity resolution system contains an effectively enumerated population for a large city (e.g., Mumbai, India) and ‘John Smith’ is the only person with that name expected to be in the large city. Consequently, the entity resolution system can confidently match an incoming record for ‘John Smith’ that includes indicia (e.g., a Postal Index Number (PIN) code) indicating that the record is associated with a person in the large city, even if other details vary, because the entity resolution system can determine that there is expected to be no other ‘John Smith’ in the effectively enumerated population. As such, this capability to detect and leverage distinctive attributes within effectively enumerated populations enables the system to improve match precision by minimizing uncertainty.

Further illustrating this concept, consider a system tasked with resolving records in a database that includes individuals from both New York City and a small village in India. In New York City, the name ‘John Smith’ is common, so the system might struggle to accurately resolve records based solely on that name. However, in the small village in India, ‘John Smith’ might be the only person expected to have that name. If the system has access to an effectively enumerated population for the small village, it can use this information to confidently resolve an incoming record, even with minimal data such as just the name, if the incoming record includes an indicium of the small town. This ability to leverage effectively enumerated populations enables the entity resolution system to make more accurate matches, reducing errors and improving overall data integrity.

To summarize, this disclosure describes enhancements to entity resolution through the real-time maintenance of categorized statistics and dynamic population enumeration. The entity resolution system tracks attribute occurrences within (hierarchical) categories (e.g., names by city, county, or region) to support real-time decision-making regarding entity resolution. As incoming records are processed, the system continuously updates categorized statistics, ensuring that entity resolution remains accurate and responsive to changes in data. Provided statistics (such as by a user) regarding categorized datasets can also inform the enumeration status of specific regions or sub-categories. Again, if a user specifies that Purcellville, Virginia has a population of 10,000 adults and the system detects matching records for a sufficient number of individuals based on the configured threshold (i.e., entities), the town-level category (i.e., the sub-category Purcellville, VA) is marked as effectively enumerated. In contrast, the system may recognize that Loudoun County, which contains Purcellville, is not effectively enumerated if only 330,000 out of 450,000 people have been recorded. This hierarchical approach enables selective enumeration, ensuring precise control over which datasets or regions are considered sufficiently covered.

The entity resolution system maintains statistics at multiple hierarchical levels as records are processed. The system uses these statistics to track the frequency and distribution of attributes within defined categories and their sub-categories. For example, in a geographic hierarchy of Country → State → County → City, the system tracks attribute frequencies at each level. When processing a record with the name “John Smith” in, for example, Mumbai, India, the system updates statistics for: The name “John Smith” in Mumbai (city level), The name “John Smith” in the containing state, and the name “John Smith” in India (country level).

Each level within a hierarchical category structure may be independently assessed for effective enumeration status. For example, a city-level category may reach effective enumeration while its containing county or state remains below the enumeration threshold, or vice versa. This independent assessment enables the entity resolution software to leverage enhanced matching capabilities at granular levels even when broader categories lack sufficient coverage, and to apply appropriate confidence adjustments based on the enumeration status of each relevant hierarchical level.

A category or sub-category becomes effectively enumerated when both conditions are met: 1) the system has received population statistics for the category and 2) the number of processed records for that category approaches (e.g., reaches a configured threshold of) the known population count. The system continuously evaluates enumeration status (i.e., whether the population has become effectively enumerated) as new records are processed.

The enumeration threshold may be expressed in multiple forms, including but not limited to: a percentage of known population (e.g., 80% of expected residents), an absolute entity count (e.g., 8,000 of 10,000 expected entities), or a dynamically determined value based on statistical reliability metrics. The flexibility in threshold expression enables the entity resolution software to accommodate various implementation approaches and data availability scenarios.

The enumeration threshold may be configured based on the certainty requirements of a particular application. For example, a fraud detection system requiring high certainty may configure an enumeration threshold of 95% population coverage, while a marketing deduplication system with more tolerance for uncertainty may operate effectively with a 75% threshold. This application-dependent configurability enables the entity resolution software to balance matching precision against data availability constraints across diverse use cases.

Categories and sub-categories, in this context, refer to the various divisions or groupings used to organize entities within a dataset. These divisions can be based on different criteria, such as logical, conceptual, or organizational relationships. For example, categories and sub-categories may be based on geographic location, demographic characteristics, product types, customer segments, or any other relevant factors that help structure and classify entities in a meaningful way. A category can refer to broad classifications (e.g., a state or demographic group), while a sub-category represents a more granular segment within that classification (e.g., a town within a state or a specific age group within a population). The use of categories and sub-categories enable the entity resolution software to evaluate the distinctiveness of data attributes based on specific contexts (i.e., categories). For instance, attributes like names or addresses that may appear common at a higher level (e.g., county or state) can become distinctive and more meaningful within a smaller sub-category (e.g., a town). By maintaining statistics at both the category and sub-category levels, the system ensures that the precision of matching improves with the granularity of the data available.

If a specific sub-category, such as a town or region, is marked as effectively enumerated, the system can dynamically adjust the weighting or behavior of attributes within that sub-category. For example, while ‘John Smith’ is typically treated as a weak identifier, the system can increase its weight if the effectively enumerated dataset confirms that only one ‘John Smith’ is expected to exist within a specific, effectively enumerated town or region, such as Mumbai, India. This capability ensures that matching decisions reflect the context and distinctiveness of data attributes. Even when a population or sub-category is not effectively enumerated, the system can refine decisions incrementally, leveraging partial data coverage to improve match accuracy over time. This adaptive behavior ensures that entity resolution operations are not constrained by incomplete data but can still evolve as new information becomes available, maintaining precision and minimizing errors in both batch and transactional processing.

The disclosure herein is not limited to or by any specific type of effectively enumerated and/or hierarchical population. Non-limiting examples of categorical or effectively enumerated populations may include geographical regions (e.g., cities, states, countries), demographic groups (e.g., age groups, income brackets), organizational hierarchies (e.g., departments within a company, or branch offices of a company), industry sectors, or other well-defined groupings where entities are systematically categorized. An example of population statistics is census data, which may incorporate a hierarchical structure, such as organizing individuals first by country, then by state, city, and finally by neighborhood. For instance, census data might categorize individuals based on their residence in a specific country, followed by their corresponding state, city, and zip code, providing a detailed hierarchical breakdown of the population.

Although the examples herein primarily illustrate entity resolution for person entities using attributes such as names and addresses, the techniques described apply equally to other entity types including but not limited to organizations, products, assets, vessels, vehicles, and any other entities that may be resolved across data sources. The enumeration and distinctiveness concepts described herein are entity-type agnostic.

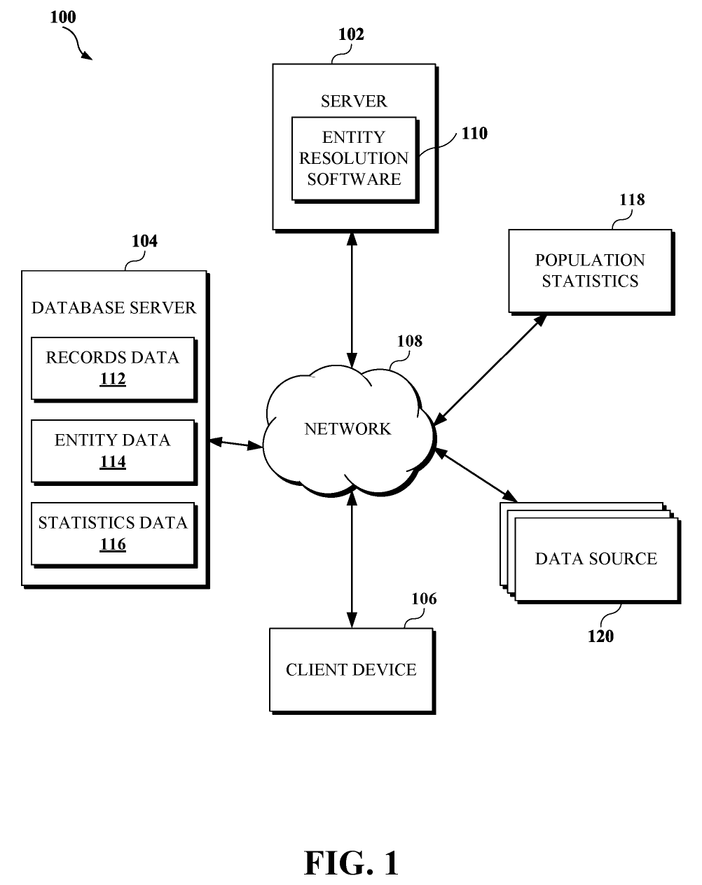

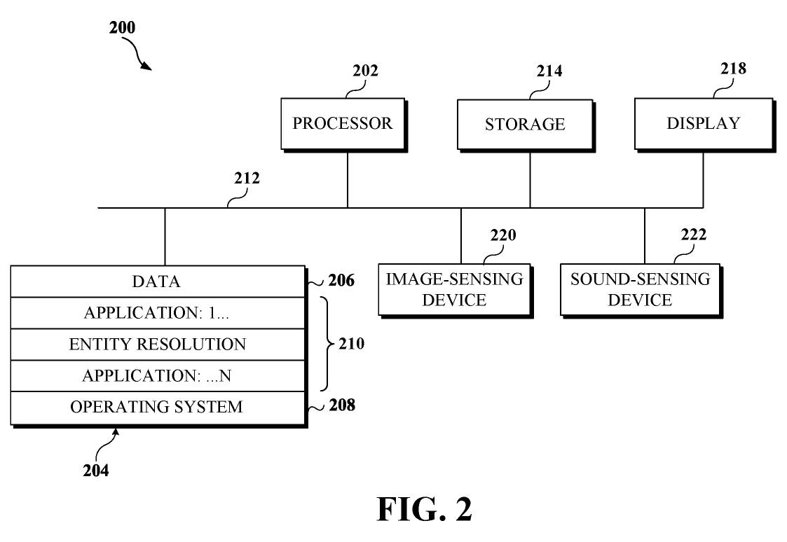

To describe some implementations in greater detail, reference is first made to examples of hardware and software structures used to implement a system for entity resolution using effectively enumerated populations. FIG. 1 illustrates an example of a block diagram of a system 100 for performing entity resolution using effectively enumerated populations. The system 100 is shown as including a server 102 (which can be one or more servers), a database server 104 (which can be one or more data servers), a client device 106 (which can be one or more client devices). These components are communicatively interconnected via a network 108, which may be implemented using any suitable communications medium, such as a wide area network (WAN), local area network (LAN), the Internet, or an Intranet. Each of the server 102, the database server 104, and the client device can be a computing device as described with respect to FIG. 2.

The server 102 is equipped with (e.g., includes or implements) an entity resolution software 110, which processes and associates various data records with common entities. Briefly, the entity resolution software 110, and as further described herein, may receive records from various sources and analyze the attributes within those records to identify potential matches with existing entities. The entity resolution software 110 compares incoming data against previously resolved entities and stored at the database server 104, to determine if the incoming records correspond to existing entities or represent new ones that may or may not relate to existing ones. By merging matching records and updating entity profiles with new information, the entity resolution software 110 builds a more complete and accurate representation of each entity over time. The entity resolution software 110 performs these tasks by leveraging data regarding entities obtained using effectively enumerated populations.

The database server 104 stores, manages, or otherwise provides data for delivering software services of the server 102 related to entity resolution. In particular, the database server 104 may implement one or more databases, tables, or other information sources suitable for use with the entity resolution software 110. A database implemented by the database server 104 may be a relational database management system (RDBMS), an object database, an eXtensible Markup Language (XML) database, a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

The database server 104 contains multiple types of information critical for the entity resolution process, including records data 112, entity data 114, and statistics data 116. The records data 112 consist of various features or characteristics pertaining to entities. The entity data 114 represents or includes the processed (i.e., identified) entities after resolution. The statistics data 116 are generated based on the data records and entity data, providing insights into the frequency and distinctiveness of attributes within the effectively enumerated populations to assist in entity resolution and identification. The statistics data 116 can also include known (e.g., loaded, provided, etc.) population statistics.

As used herein, the term “record” refers to any structured or unstructured set of data, regardless of format, that contains one or more data attributes or fields associated with an entity. A record is not limited to the context of a relational database; rather, it encompasses data sets from various sources, including but not limited to, text files, XML documents, JavaScript Object Notation (JSON) objects, sensor data streams, Application Programming Interface (API) responses, HyperText Markup Language (HTML) requests, and any other form of data representation. For example, an incoming record may be received as part of an HTML request, such as within the payload of an HTTP POST request or as query parameters in a GET request. Each record may include, for example, identifiers, attributes, metadata, or other data elements that collectively describe or pertain to an entity, such as a person, organization, object, or event. The structure and content of a record may vary depending on the source and the context in which it is used, but it fundamentally serves as a discrete unit of information within the system.

The client device 106 enables a user to interact with the entity resolution software 110, such as by inputting queries and receiving outputs related to entity resolution tasks. Via the client device 106, the user can provide population statistics 118.

The entity resolution software 110 receives population statistics 118, which include information about population sizes within various categories and sub-categories (e.g., the number of adult residents in a city or region). The entity resolution software 110 uses the population statistics 118 to determine when categories become enumerated as records are processed. For example, when the number of identified unique entities for a category, as records are processed, approaches (e.g., equals) the known population count from the population statistics 118, that category can be marked as enumerated.

The entity resolution software 110 identifies (e.g., creates) entities based on processed records and incorporates these entities into the entity data 114. The entity resolution software 110 also generates and maintains category-level statistics that are incorporated into the statistics data 116 for use in entity resolution. These statistics track attribute frequencies and distributions within categories, enabling the system to make more informed matching decisions as categories become enumerated.

The entity resolution software 110 receives incoming record data from one or more data sources, such as the data source 120. These data records may be used by the entity resolution software 110 to identify new entities, merge entities, split one entity into two or more entities, identify related entities, and the like. The data records may be received one at a time or in batches. In an example, via user interfaces available at the client device 106 and associated with the entity resolution software 110, a user may enter data records or provide batches of data records for processing by the entity resolution software 110. As the incoming record data from the one or more data sources are ingested (e.g., processed), the entity resolution software 110 may update statistics data 116 based on attribute values identified in the incoming record data.

FIG. 2 is a block diagram illustrating an example internal configuration of a computing device 200. In one configuration, the computing device 200 may implement one or more of the components from the system 100 depicted in FIG. 1, such as the client device 106, the server 102, or the database server 104. The computing device 200 can be a standalone system or part of a distributed system and may take various forms, including a mobile phone, tablet computer, laptop, desktop computer, or other similar devices.

A processor 202 is responsible for executing instructions and processing data within the computing device 200. The processor 202 may be a conventional central processing unit (CPU), or it could consist of multiple processing units or specialized hardware designed for specific computational tasks. Although the depicted implementation shows a single processor, the computing device 200 may include multiple processors working in tandem to achieve improved speed and efficiency.

A memory 204 serves as a storage medium for data and instructions used by the processor 202. This memory may be implemented as read-only memory (ROM), random access memory (RAM), or other suitable storage technologies. The memory 204 contains code and data 206 that are accessed by the processor 202 via a bus 212. In addition to an operating system 208, the memory 204 includes application programs 210. The application programs 210 may encompass a range of functionalities, including an entity resolution software that performs the techniques described herein. The computing device 200 may also incorporate secondary storage 214, such as a memory card, which provides additional storage capacity. This secondary storage 214 is particularly useful for storing large datasets, such as data records, entity data, and statistics data, which can be loaded into the memory 204 for processing as needed.

The computing device 200 can also be equipped with one or more output devices, such as a display 218. The display 218 may be a touch-sensitive screen that combines display and input functionalities, allowing the user to interact directly with the computing device 200. The display 218 is connected to the processor 202 through the bus 212. Alternative output devices may also be included, providing users with numerous ways to interact with the computing device 200. The display 218 can be implemented using different technologies, such as liquid crystal display (LCD), cathode-ray tube (CRT), or light-emitting diode (LED) displays, including organic LED (OLED) displays.

The computing device 200 can further include or be connected to an image-sensing device 220, such as a camera, capable of capturing images, including those of a user of the computing device 200. The computing device 200 may include or interface with a sound-sensing device 222, such as a microphone, designed to capture audio input. Both image-sensing and sound-sensing devices can be implemented using current or future technologies that enhance the interaction capabilities of the computing device 200.

Although FIG. 2 depicts the processor 202 and memory 204 as integrated components within a single unit, the architecture of the computing device 200 is flexible and can be adapted to various configurations. The operations of the processor 202 may be distributed across multiple devices, each equipped with one or more processors, and connected either directly or through a network, such as a local area network (LAN). Similarly, the memory 204 can be distributed across multiple storage devices, including network-based memory or storage spread across multiple machines that collectively perform the functions of the computing device 200. Although the bus 212 is shown as a single component in FIG. 2, it may actually consist of multiple interconnected buses. The secondary storage 214 can either be directly connected to the other components of the computing device 200 or accessed over a network, and it may consist of a single storage unit or multiple interconnected units, such as multiple memory cards. Thus, the computing device 200 can be configured in various ways to meet different operational requirements.

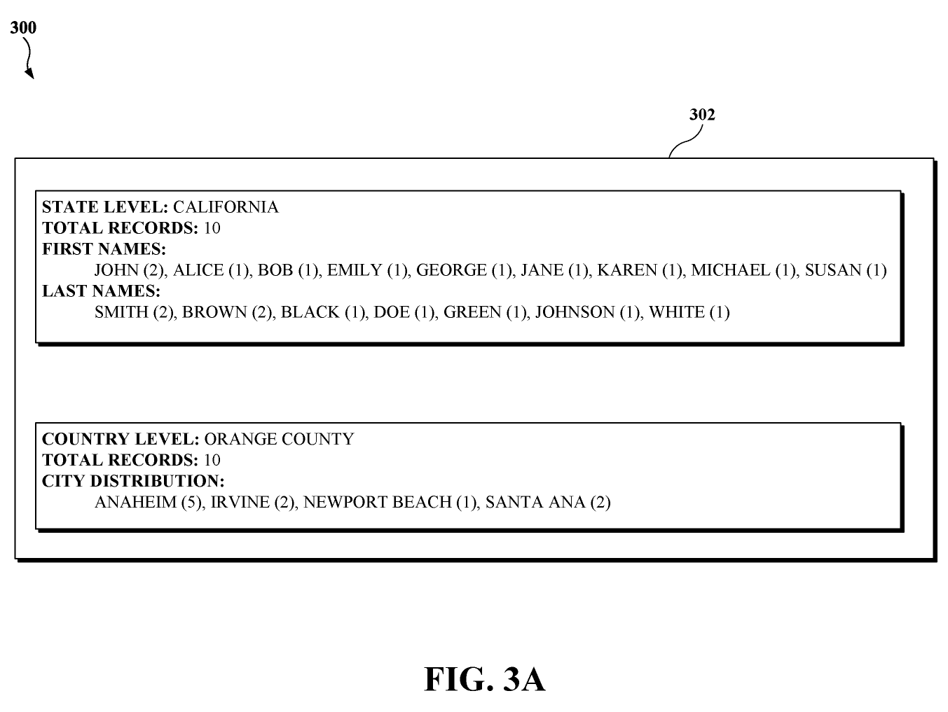

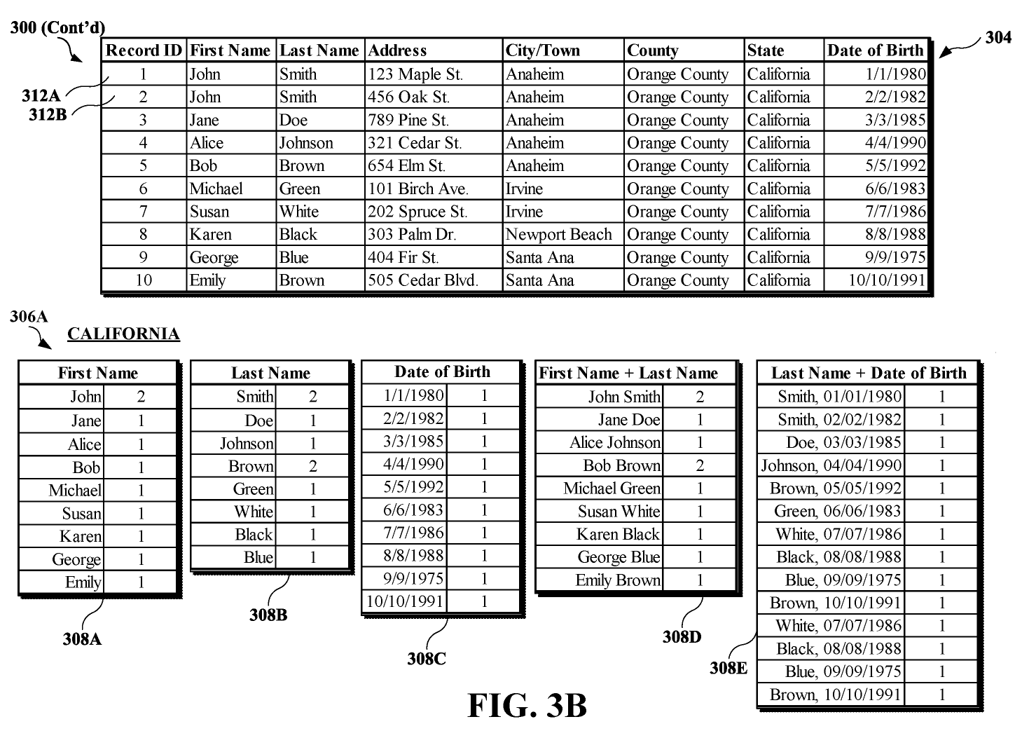

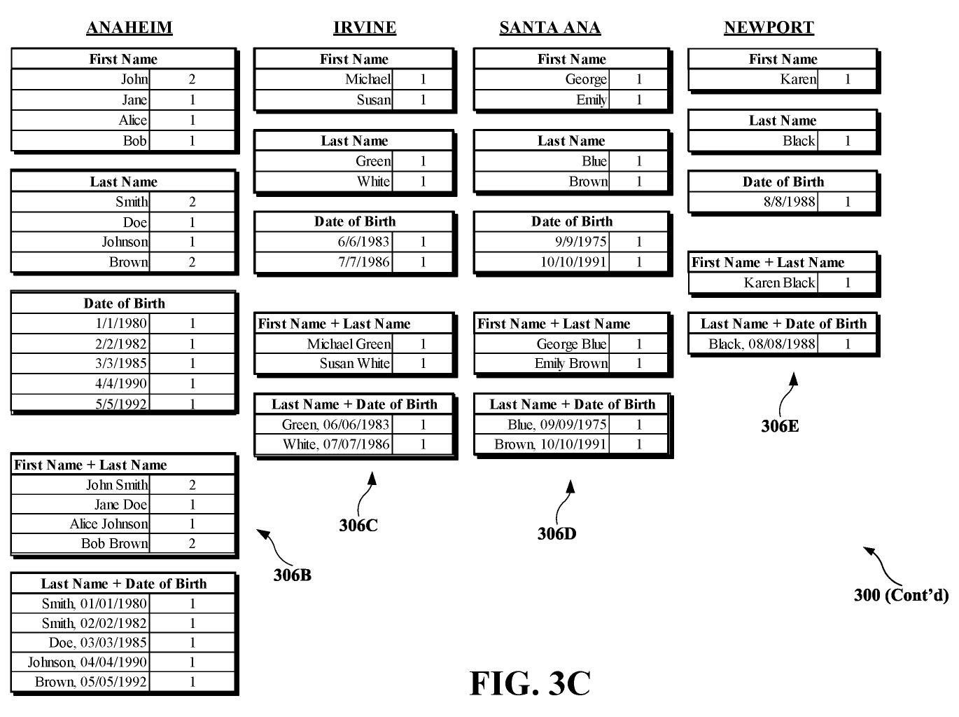

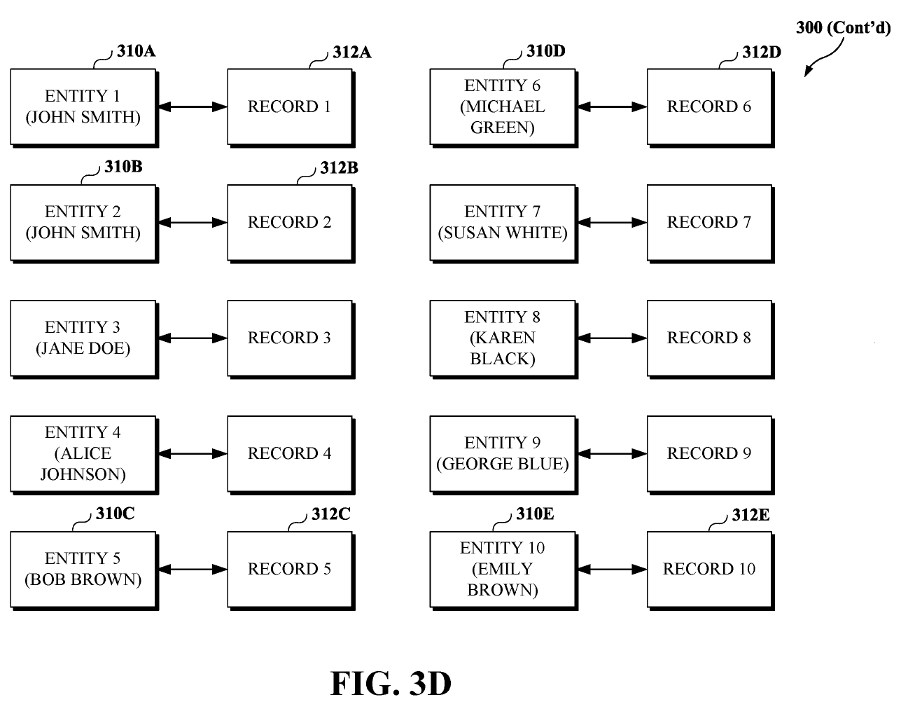

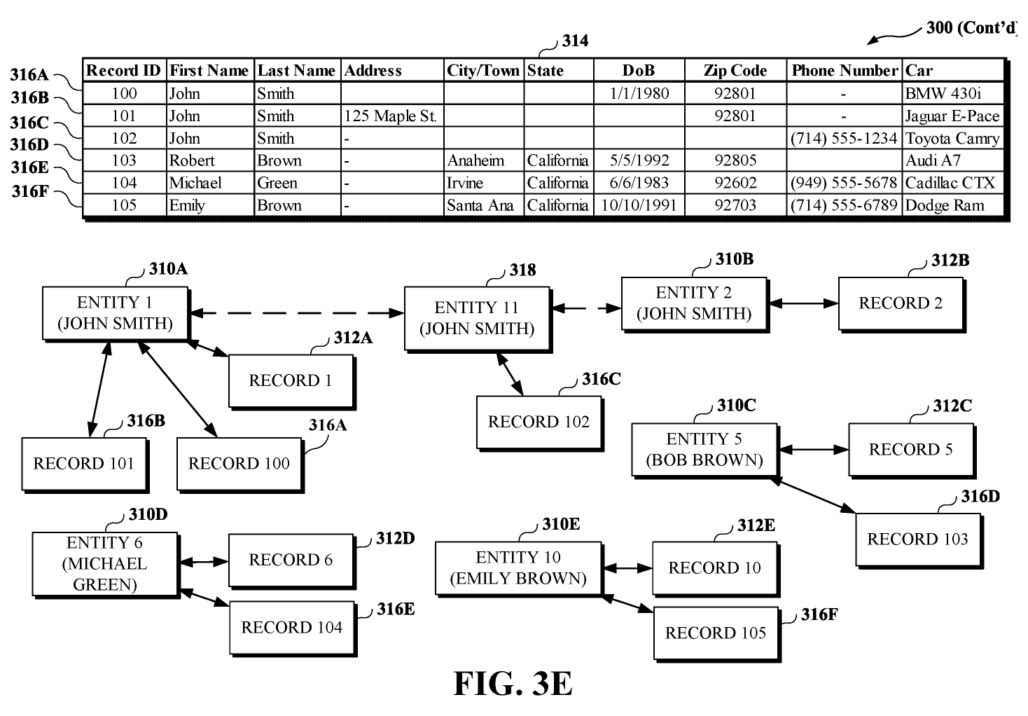

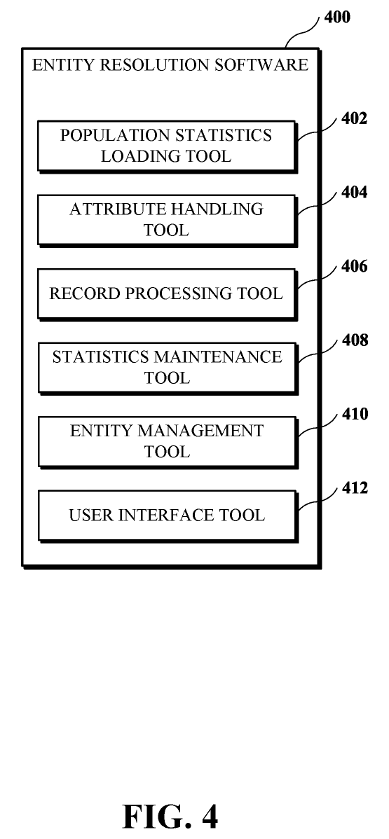

FIGS. 3A-3E illustrate an example 300 of entity resolution using population statistics and enumerated datasets. The processing described with respect to example 300 can be performed by an entity resolution software, such as the entity resolution software 110 of FIG. 1 or the entity resolution software described with respect to FIG. 4.

FIG. 3A illustrates population statistics 302 received by the entity resolution software. It is noted that the disclosure herein is not limited to or by any particular set of statistics or format shown by the population statistics 302. In the illustrated example, at the state level for California, the statistics show frequencies of first names and last names across 10 total persons (e.g., entities), where certain names like “JOHN” (2 occurrences) and “SMITH” (2 occurrences) are known to appear multiple times while others appear only once. At the county level for Orange County, the statistics show the distribution of persons across cities, with ANAHEIM having the highest concentration (5 persons), followed by IRVINE and SANTA ANA (2 persons each), and NEWPORT BEACH (1 person). These statistics include known population counts for each geographic region (not shown in FIG. 3A), such as the total number of adult residents in each city.

The entity resolution software receives population statistics 302, which include both known population counts and frequencies/distributions of attributes within different categories having a specific scope or context, such as geographical or organizational boundaries, as shown in FIG. 3A. After a certain period of processing of incoming records against these population statistics 302, the entity resolution software accumulates a dataset of processed records while tracking progress toward enumeration thresholds. The entity resolution software determines enumeration status by comparing the number of identified entities in a category against its known population count from the population statistics 302. When the number of entities for a category (e.g., geographic region) approaches its known population count for that category, the population associated with that category becomes (e.g., is flagged as being) enumerated. In this example, after sufficient processing time, the accumulated dataset becomes an effectively enumerated dataset 304, shown in FIG. 3B.

Both the population statistics 302 and effectively enumerated dataset 304, for ease of understanding, are organized according to hierarchical categories. In this example, the hierarchy is State → County → City/Town. However, categories may not necessarily include a hierarchy. In other examples, the entity resolution software may receive input or configuration data indicating whether a hierarchy is present and, if so, defining the attributes that constitute the hierarchy. The hierarchical organization allows the entity resolution software to generate more granular and context-specific statistics that can improve the accuracy of entity resolution based on enumeration status at different category levels.

As the entity resolution software processes incoming records that form the effectively enumerated dataset 304, it creates entities and maintains three types of statistics: the initial population statistics 302, statistics derived from processed records, and enumeration status tracking. The software generates statistics corresponding to each level of the hierarchy, allowing it to determine when different categories become enumerated. These statistics include counts and occurrences of specific attributes and combinations of attributes (i.e., compound attributes) within the identified entities. The software tracks both individual attributes and compound attributes that combine two or more attributes (e.g., first name + last name), as these combinations can become strong identifiers within enumerated categories.

FIG. 3B shows a subset of statistics generated by the entity resolution software. Statistics 306A are generated for the highest level of the hierarchy (e.g., the state level), and statistics 306B through 306E (i.e., statistics 306B, 306C, 306D, and 306E) are generated for the lowest level of the hierarchy (i.e., the city/town levels). Although not specifically shown, the entity resolution software also generates statistics for any intermediate levels of the hierarchy (in this case, the county level). The software continuously updates these statistics as new records are processed, recalculating enumeration status whenever the processed record count approaches the known population count for a category.

Each of the statistics 306A through 306E includes counts of different attributes within the identified entities, which are compared against the known population counts from statistics 302 to determine enumeration status. For brevity, only a subset of the generated statistics is shown in the example 300. Specifically, statistics for the attributes First Name, Last Name, and Date of Birth are illustrated, as shown in statistics 308A-308C (i.e., statistics 308A, 308B, and 308C). Additionally, the entity resolution software generates statistics for compound attributes. For instance, statistics 308D and 308E correspond to the compound attributes First Name + Last Name and Last Name + Date of Birth, respectively. The entity resolution software may generate statistics for all n-tuple (e.g., 2-tuple, 3-tuple) compound attributes, depending on the configuration or inputs received. When a category becomes enumerated, these compound attributes can become stronger identifiers within that category’s context.

In some implementations, the entity resolution software may receive inputs indicating which specific attributes and compound attributes to generate statistics for, as well as the population counts needed to determine enumeration status. This flexibility allows the entity resolution software to tailor both the statistics generation process and enumeration detection to the specific needs of the application, thereby enhancing the accuracy and efficiency of the entity resolution process.

FIG. 3D illustrates that the entity resolution software creates entities from processed records as the effectively enumerated dataset 304 is built up over time. Each entity is associated with its corresponding record from the effectively enumerated dataset 304. To illustrate, entities 310A, 310B, 310C, 310D, and 310E are created from and associated with records 312A, 312B, 312C, 312D, and 312E, respectively. The enumeration status of each entity’s associated categories affects how subsequent matching decisions are made.

Continuing with the example 300, FIG. 3E illustrates how the entity resolution software processes incoming records 314 (e.g., transactional records, which may be received individually at separate times) related to car purchases or car ownerships. Each incoming record may include at least a subset of attributes such as First Name, Last Name, Address, City/Town, State, Date of Birth (DoB), Zip Code, Phone Number, and Car. The entity resolution software processes each of these incoming records as they are received, using the enumeration status of relevant categories to adjust matching confidence and determine whether the records correspond to previously established entities.

With respect to a record 316A, the entity resolution software determines that the zip code 92801 corresponds to the city of Anaheim, which is now an effectively enumerated dataset 304. Based on the compound attribute “Last Name + DoB” (e.g., “Smith, 01/01/1980”) and the statistics 306B, the entity resolution software determines that the record 316A is associated with entity 310A shown in FIG. 3C. Because Anaheim is enumerated, the entity resolution software can make this match with high confidence, knowing it has visibility into the complete population. Consequently, an association is created between entity 310A and record 316A, as shown in FIG. 3E.

With respect to record 316B (RECORD 101), the entity resolution software again determines that the zip code 92801 corresponds to the city of Anaheim. Then, based on the compound attribute “First Name + Last Name” (e.g., “John Smith”), the statistics 306B, and the high similarity between the Address attribute of record 316B and that of record 312A, the entity resolution software determines that the entity indicated by record 316B is the same as entity 310A. The enumeration status of Anaheim increases confidence in this match, as the software knows it has processed all “John Smith” records in the city. Thus, an association is created between entity 310A and record 316B, as shown in FIG. 3E.

With respect to record 316C, the entity resolution software determines that the area code (e.g., 714) of the phone number corresponds to the city of Anaheim. However, based on the statistics 306B, the entity resolution software cannot identify a distinctively matching entity because the compound attribute “First Name + Last Name” (e.g., “John Smith”) appears multiple times in the effectively enumerated population, and no other distinguishing data is available in record 316C. Even though Anaheim is enumerated, multiple “John Smith” entities exist within the effectively enumerated population, preventing a definitive match. As a result, the entity resolution software creates a new entity 318, associates record 316C with the new entity 318, and links the new entity 318 to both entity 310A and entity 310B in FIG. 3D with a “probably same” relationship, indicated by the dashed arrows. The entity resolution software updates (not shown) the statistics to indicate that John, Smith, and “John Smith” are associated with an additional entity (e.g., the new entity 318).

With respect to record 316D (RECORD 103), the entity resolution software determines that record 316D should be associated with entity 310C in FIG. 3D. Despite the difference in the first name (“Robert” instead of “Bob”), the Last Name, Date of Birth, and City match. The entity resolution software includes intelligence (e.g., field handlers) configured to recognize that “Bob” and “Robert” are common variants of the same name. The enumerated status of the city category helps confirm this match, as the software can be confident it has processed all relevant records. Consequently, an association is created between entity 310C and record 316D, as shown in FIG. 3E.

With respect to record 316E, the entity resolution software compares this record against the enumerated dataset and finds a match with entity 310D in FIG. 3D. The area code of the phone number corresponds to Irvine, which has not yet reached enumeration status. However, because other strongly matching attributes are present, the software can still create the match, though with potentially lower confidence than matches in enumerated categories. An association is created between entity 310D and record 316E, as shown in FIG. 3E.

With respect to record 316F (RECORD 105), the entity resolution software compares this record against the enumerated dataset and finds a match with entity 310E in FIG. 3C. While this match is in a non-enumerated category, the presence of sufficient matching attributes allows the association to be created between entity 310E and record 316F, as shown in FIG. 3E. The non-enumerated status of the category is reflected in the confidence level of the match.

The enumeration status of categories influences how the entity resolution software evaluates matches. In enumerated categories, where the number of identified entities approaches the known population count, the entity resolution software can make stronger assertions about the uniqueness (e.g., distinctiveness) of attribute combinations. For example, when matching records in an enumerated city category, the software can treat typically weak identifiers as strong identifiers if they are distinctive within the effectively enumerated population, such as when only one “John Smith” exists in that city. The software can also confidently determine when an apparent match is likely incorrect, such as when matching would imply more instances of an attribute combination than exist in the effectively enumerated population. Furthermore, in enumerated categories, the software can make decisive non-match determinations by effectively determining that two similar records represent different entities because all potential matches in the effectively enumerated population have been accounted for.

Conversely, in non-enumerated categories, where the number of identified entities is significantly below the known population count, the entity resolution software maintains more conservative matching behaviors. Common identifiers, such as names, retain their default weak matching importance, and additional corroborating attributes are required to establish matches. Ambiguous matches in non-enumerated categories are more likely to result in “possibly same” relationships rather than definitive matches. Match confidence scores are adjusted downward to reflect the incomplete population coverage in these categories.

The entity resolution software may also leverage enumeration status across category hierarchies. For example, if a city-level category is enumerated but its containing county is not, the software can make high-confidence matches for records specifically associated with the enumerated city while applying normal matching rules for records in non-enumerated parts of the county. The entity resolution software can use the enumerated city’s statistics to inform matching decisions in nearby non-enumerated areas when appropriate. When records have ambiguous geographic indicators that could span enumerated and non-enumerated categories, the software may adjust match confidence accordingly, such as by defaulting to the more conservative non-enumerated matching behavior unless strong corroborating evidence exists.

FIG. 4 is a block diagram of an entity resolution software 400, which may be the entity resolution software 110 of FIG. 1. The entity resolution software 400 can include programs, subprograms, functions, routines, subroutines, operations, executable instructions, callable instructions or services, and/or the like for, inter alia and as further described herein, facilitating the operations of entity resolution using population statistics and enumerated categories. The entity resolution software 400 is shown as including a population statistics loading tool 402, an attribute handling tool 404, a record processing tool 406, a statistics maintenance tool 408, an entity management tool 410, and a user interface tool 412. A “tool,” as used herein, refers to any combination of executable instructions, application programming interfaces (APIs), software development kits (SDKs), frameworks, or modules designed to perform specific functions or facilitate operations within a software or hardware environment.

The population statistics loading tool 402 is configured for importing and managing population statistics that enable entity resolution with category-level context. The tool processes, for example user-provided, population statistics (e.g., counts) for categories and sub-categories (e.g., “City A has 10,000 adult residents,” “County B, that includes City A, has 450,000 residents”). The population statistics loading tool 402 maintains these statistics in a hierarchical structure, allowing population data to be organized at multiple levels such as city, county, state, or other user-defined categories. As the entity resolution software 400 processes records, the population statistics loading tool 402 works in conjunction with the statistics maintenance tool 408 to track progress toward enumeration thresholds. For example, when the number of identified entities for (e.g., associated with or include) a category approaches the loaded population statistic for that category, the tool can mark that category as enumerated.

The attribute handling tool 404 manages attribute processing and normalization across all incoming records. The attribute handling tool 404 includes or can be configured with specialized attribute handlers that can map attribute values to categories. For instance, a telephone area code may be mapped to one or more cities; a zip code may be mapped to a specific city or region; and a state code may be mapped to a broader geographical area such as a region or a country. The attribute handling tool 404 can also normalize and standardize attributes to ensure consistency across the dataset. For example, address formats may be standardized, common data entry errors may be corrected, and variations in name spellings may be handled or recognized. As such, the attribute handling tool 404 can ensure that attributes are correctly interpreted and aligned with the corresponding categories in the system, thereby improving the accuracy of the entity resolution process when evaluating records against both enumerated and non-enumerated categories.

The attribute handling tool 404 can be further configured to determine similarities between attribute values, allowing the entity resolution software to more accurately match records that may not be identical but are closely related. For example, a first name attribute handler within the attribute handling tool 404 may be configured to recognize that “Bob” and “Robert” are common variants of the same name and therefore treat them as equivalent for matching purposes. Additionally, the attribute handling tool 404 can be configured to identify similarities based on calculated similarities (e.g., based on edit distances) between attribute values. Such distances may be computed using various algorithms, such as Levenshtein distance, which measures the number of single-character edits (insertions, deletions, or substitutions) required to change one string into another, or Jaccard similarity, which compares the similarity and diversity of sample sets. For instance, the attribute handling tool 404 may determine that “Johnathan” and “Jonathan” have a small Levenshtein distance and thus may represent the same value. The attribute handling tool 404 may also include specialized handlers for other attribute types, such as address handlers that standardize formats and recognize equivalent locations (e.g., “Street”/”St.”, “Avenue”/”Ave.”). These similarity determinations can be particularly valuable when evaluating records in enumerated categories, where the completeness of population coverage allows for more confident matching decisions.

The record processing tool 406 is configured for ingesting and processing incoming records as they are received by the entity resolution software 400. The record processing tool 406 parses incoming data, identifies key attributes, and prepares the records for comparison against the existing entities in the database. More accurately, the record processing tool 406 may identify possible existing entities based on the data values (e.g., attribute values) included in the incoming records and associate the incoming records therewith or create new entities. The record processing tool 406 may also handle batch processing of records, allowing large volumes of data to be processed efficiently.

The statistics maintenance tool 408 manages and continuously updates three distinct types of statistics: known population counts (from the population statistics loading tool 402), processed record statistics, and enumeration status tracking. The tool maintains these statistics at each level of the category hierarchy (e.g., city, county, state), tracking the occurrence, frequency, and distribution of attribute values, including compound attributes (e.g., combinations such as first name, last name, and date of birth). As records are ingested—either individually through real-time transactions or in bulk through batch operations—the statistics maintenance tool 408 dynamically updates the relevant statistics to maintain accuracy and data integrity.

The statistics maintenance tool 408 updates statistics differently based on whether it encounters new or existing attribute combinations. When a new record contains previously unseen attribute values or combinations, the tool updates the relevant counts and frequencies at each category level. However, when a record matches existing attribute combinations without introducing new values, the statistics remain unchanged. For example, if a record for “Emily Brown” with date of birth “10/10/1991” represents a new combination for Santa Ana, California, the tool updates both the individual attribute frequencies and the compound attribute statistics. Conversely, if a record for “John Smith” with date of birth “01/01/1980” matches an existing combination in Anaheim, California, the statistics remain unchanged.

The tool monitors progress toward enumeration thresholds by comparing identified entity counts against known population counts for each category. When a category becomes enumerated, the tool can make stronger assertions about the distinctiveness of attributes within that category’s context. For instance, when evaluating matches based on names, the tool treats “John Smith” differently depending on the enumeration status of the relevant category—maintaining default importance in non-enumerated regions but potentially treating it as a strong identifier in enumerated regions where it is known to be distinctive.

When processing records that result in weak matches (e.g., matching only on name and city), the statistics maintenance tool 408 adjusts match importance based on category enumeration status and hierarchical relationships. The tool applies different importance levels for matches in enumerated versus non-enumerated categories. For example, a match in a non-enumerated region maintains default importance levels, while a match in an enumerated region may receive increased importance when attribute distinctiveness is confirmed by population statistics.

The statistics maintenance tool 408 includes re-evaluation capabilities triggered by changes in enumeration status. When a category becomes enumerated (e.g., when the number of identified entities approaches the known population count), the tool automatically reviews previous match decisions that could be affected by this new enumeration status. This review considers both the newly enumerated category and related categories in the hierarchy. For example, if an earlier match decision was made with low confidence due to incomplete population coverage, the tool may increase that confidence once the relevant category becomes enumerated.

Through this continuous maintenance of statistics at multiple hierarchical levels and dynamic adjustment of match importance based on enumeration status, the statistics maintenance tool 408 enables increasingly precise entity resolution as more data is processed. The tool’s ability to track category-level statistics, monitor enumeration status, and adjust matching behavior accordingly ensures that the entity resolution software 400 makes decisions that reflect the current state of population coverage while maintaining consistency across both individual and batch processing operations.

The entity management tool 410 manages the creation, deletion, or merging of entities. The entity management tool 410 handles the creation of new entities when incoming records do not match any existing entities, the merging of records that correspond to the same entity, and the splitting of entities when it is determined that a previously merged entity actually represents multiple distinct entities. The entity management tool 410 also manages the relationships between entities (such as familial, business connections, or any other contextually relevant connection) and can update these relationships as new data becomes available. The entity management tool 410 may maintain different types of relationships between entities, such as “same” when two entities (i.e., entity objects in a data store) correspond to the same entity, “possibly same,” when two entities are suspected to be the same, and “related.” When establishing these relationships, the confidence in the relationship type may be influenced by whether the entities belong to enumerated categories.

The user interface tool 412 provides a graphical user interface (GUI) or command-line interface (CLI) for users to interact with the entity resolution software 400. The user interface tool 412 allows users to input data, configure settings, review entity resolution outcomes, generate reports, and submit queries related to the data stored or managed by the entity resolution software 400. The user interface tool 412 enables users to input and manage population statistics for different categories, and monitor progress toward enumeration thresholds. The user interface tool 412 can present visualizations of the entity resolution process, such as displaying the results of matching algorithms, highlighting potential conflicts, and showing the relationships between entities. The user interface tool 412 may also include tools for manual intervention, allowing users to review and override automated decisions when necessary. Additionally, the user interface tool 412 can provide audit and traceability features, enabling users to track the history of changes made to entities and review the rationale behind specific entity resolution decisions, including how enumeration status influenced match confidence.

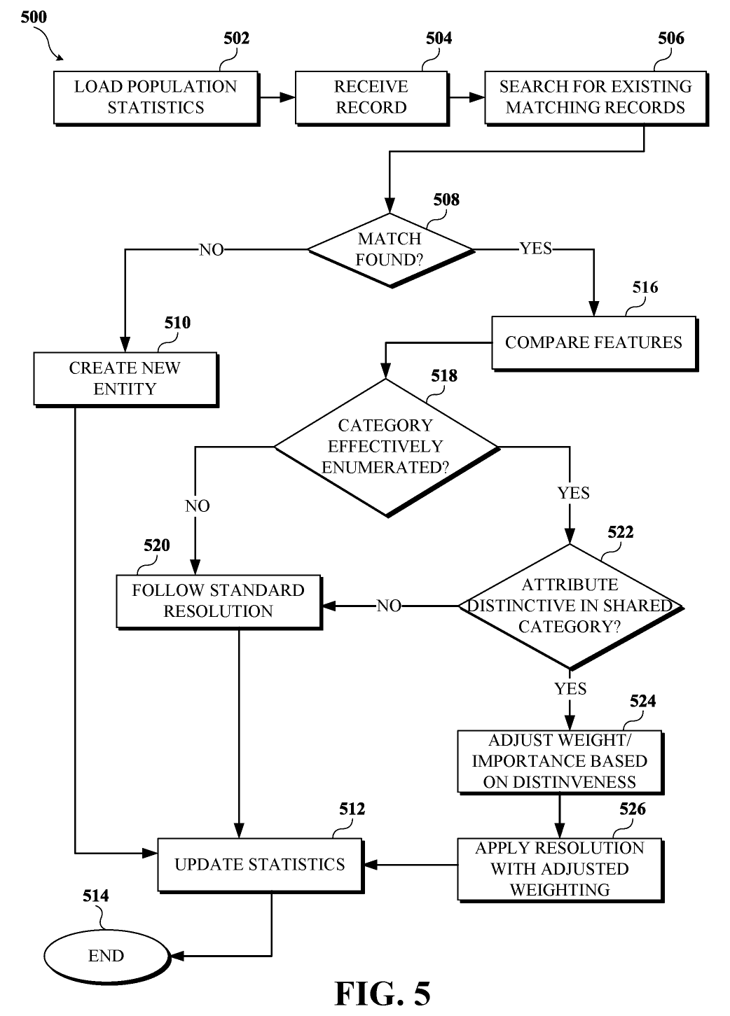

To further describe some implementations in greater detail, reference is next made to examples of techniques which may be performed by or using an entity resolution software. FIG. 5 is a flowchart of an example of a technique 500 for entity resolution using effectively enumerated populations. The technique 500 can be executed using computing devices, such as the systems, hardware, and software described with respect to FIGS. 1-4. The technique 500 can be performed, for example, by executing a machine-readable program or other computer-executable instructions, such as routines, instructions, programs, or other code. The steps, or operations, of the technique 500, or another technique, method, process, or algorithm described in connection with the implementations disclosed herein can be implemented directly in hardware, firmware, software executed by hardware, circuitry, or a combination thereof. The technique 500 can be performed by an entity resolution software, such as the entity resolution software 400 of FIG. 4.

The technique 500 begins at block 502 with the loading of population statistics. These statistics may consist of categorized data, such as regional population distributions or attribute frequencies across hierarchical levels (e.g., city, county, state). The statistics provide a reference for matching incoming records. At block 504, a new record (e.g., an incoming record) is received. The record may include attributes such as a name, address, date of birth, or other identifying information. For example, the new record may be for a “John Smith.”

At block 506, the technique 500 searches for any existing matching entities within entity data, such as the entity data 114 of FIG. 1. The search process involves comparing the attributes of the incoming record against those of existing entities in the population of the entity data. At 508, the technique 500 determines whether a match is found. If no match is found (“No” branch), the technique 500 proceeds to block 510, where a new entity is created for the incoming record. At 512, statistics, such as the statistics data of FIG. 1, are updated to reflect the addition. After updating the statistics, the technique 500 concludes at block 514.

If a match is found at 508 (“Yes” branch), the technique 500 proceeds to 516, where the features (e.g., attributes) of the matched record and the incoming record are compared. The comparison evaluates shared attributes (e.g., name, location, birthdate) to determine whether the match can be resolved using default rules or if further evaluation of regional data is needed to refine the match. At 518, the technique 500 checks whether any category (e.g., city) associated with the matched record and the incoming record has been determined to be effectively enumerated based on the population statistics and the entity data. Effective enumeration indicates that sufficient population coverage for a specific category has been reached, enabling the technique 500 to identify distinctive (contextually rare or uncommon) attributes within that scope. If the categories are not effectively enumerated (“No” branch), the technique follows standard resolution logic at block 520. This involves resolving the match using default attribute weights, updating the population statistics, and concluding the process.

If the categories are effectively enumerated at 518 (“Yes” branch), the technique 500 proceeds to block 522, where it checks whether an attribute in the record is expected to be distinctive (e.g., expected to be unique) within the shared category. For example, the system may determine that the name “John Smith” is expected to be distinctive within a specific city like Mumbai. In this context, distinctiveness refers to attributes that are rare or singular within the effectively enumerated context. If no distinctive attribute is found (“No” branch, at 522), the technique 500 performs standard resolution logic, at 520.

If an attribute is found to be distinctive within the shared category (“Yes” branch, at 522), the technique 500 advances to block 524 to adjust the weight or importance of the distinctive attribute. This adjustment reflects the increased significance of the attribute for resolving records within the shared category. For instance, if “John Smith” is expected to be distinctively identified in Mumbai, the system increases the importance of the name attribute for comparison in that context.

At block 526, the technique 500 applies the resolution using the adjusted attribute weighting. This ensures that the match is performed with an increased certainty level based on the distinctive significance of specific attributes. The resolution is performed using the adjusted attribute weighting, which takes into account the distinctiveness of the attributes within the shared category. Following this resolution, the population statistics are updated at block 512 to reflect the refined match or adjustments made. The process then concludes at block 514.

In the context of entity resolution, and as used herein, “distinctive data” refers to data attributes that are rare or uncommon within a specific category or level of a hierarchical population. Distinctiveness in this context is not necessarily absolute but relative to the effectively enumerated region or category, meaning that an attribute is considered distinctive if its occurrence is significantly lower compared to other attributes in that same context. If the technique 500 does not identify any distinctive data in the incoming record (i.e., attributes that are sufficiently rare within the effectively enumerated region), the technique 500 cannot leverage categorical (e.g., category level) specificity to enhance confidence in the match. In such cases, the process proceeds without further refinement of the confidence level, relying instead on standard resolution logic.

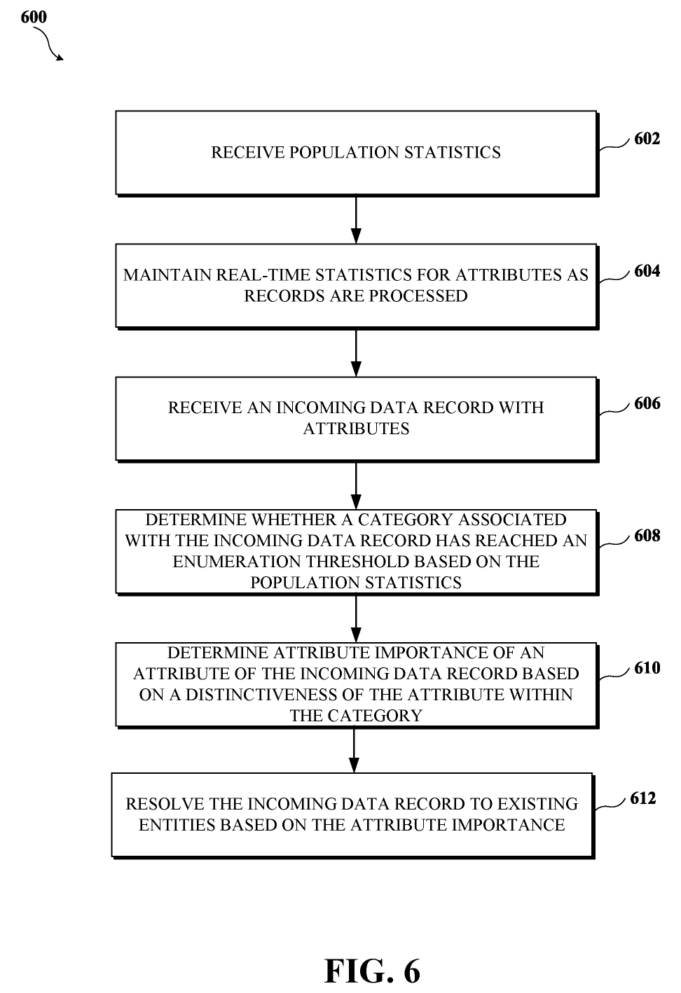

FIG. 6 is a flowchart of an example of a technique 600 for entity resolution using effectively enumerated populations. The technique 600 can be executed using computing devices, such as the systems, hardware, and software described with respect to FIGS. 1-5. The technique 600 can be performed, for example, by executing a machine-readable program or other computer-executable instructions, such as routines, instructions, programs, or other code. The steps, or operations, of the technique 600, or another technique, method, process, or algorithm described in connection with the implementations disclosed herein can be implemented directly in hardware, firmware, software executed by hardware, circuitry, or a combination thereof. The technique 600 can be performed by an entity resolution software, such as the entity resolution software 400 of FIG. 4.

At 602, population statistics are received. The technique 600 may receive the population statistics from various sources, such as census data, user input, or third-party databases. These population statistics may include total population counts for different categories and hierarchical levels (e.g., city, county, state) and may also include attribute frequencies within each category.

At 604, real-time statistics for attributes are maintained as records are processed. Maintaining real-time statistics for attributes within categories may include updating attribute frequency counts for each category and re-evaluating enumeration thresholds based on the updated frequency counts. As incoming records are processed, the technique 600 continuously updates the real-time statistics for each attribute within the relevant categories. This may include incrementing frequency counts, updating distributions, and calculating ratios or percentages. The technique 600 also tracks the number of unique entities identified for each category and compares it against the total population count to determine the progress towards enumeration thresholds

At 606, an incoming data record with attributes is received. The technique 600 receives the incoming data record for resolving to an existing entity or to be identified as a new entity. The incoming data record may contain various attributes such as name, address, date of birth, or other identifying information. In an example, the population statistics may be organized according to hierarchical categories that include a category associated with the incoming data record, and may include a total population count for each of the hierarchical categories.

At 608, it is determined whether the category associated with the incoming data record has reached an enumeration threshold based on the population statistics. The enumeration threshold may be determined based on a comparison between a number of identified entities and a total population count for the category provided by the population statistics. The technique 600 identifies the category or categories associated with the incoming record based on its attributes (e.g., using geographic codes, organizational hierarchies). It then checks whether each associated category has reached its enumeration threshold by comparing the number of identified entities against the total population count for that category. Enumeration thresholds can be set as a percentage of the total population (e.g., 70%, 80%, 90%, 95%, or another configurable percentage based on application requirements coverage) or an absolute number.

At 610, an attribute importance of the attribute of the incoming data record is determined based on the distinctiveness of the attribute within the category associated with the incoming data record. The distinctiveness can be determined based on the maintained real-time statistics for the attribute in response to determining that the category has reached the enumeration threshold. The attribute importance may be dynamically adjusted by increasing a weight of the attribute if the attribute is distinctive within the category and the category has reached the enumeration threshold. If the associated category has reached its enumeration threshold, the technique 600 evaluates the distinctiveness of each attribute in the incoming record within that category. It uses the maintained real-time statistics to calculate the frequency or rarity of each attribute value among the identified entities. Attributes that are highly distinctive or rare within the effectively enumerated category are assigned higher importance scores, as they are more likely to provide discriminating power for entity resolution. The technique 600 dynamically adjusts these importance scores based on the enumeration status and the real-time statistics.

At 612, the incoming data record is resolved to existing entities based on the attribute importance. Using the dynamically adjusted attribute importance scores, the incoming record is compared to existing entities within the effectively enumerated category. The technique 600 calculates match scores based on the similarity of attribute values, weighted by their importance. If a match score exceeds a predefined threshold, the incoming record is resolved to that existing entity. If no match is found, a new entity may be created. The resolution process prioritizes attributes that are distinctive within the effectively enumerated category, as they are more likely to provide accurate matches. Resolving the incoming data record to existing entities may include determining a degree of similarity between the incoming data record and each existing entity, calculating a match score for each existing entity based on the degree of similarity, and associating the incoming data record with an existing entity having a match score exceeding a threshold.

The technique 600 may further include creating a new entity associated with the incoming data record if no existing entity matches the incoming data record.

To illustrate, consider a scenario where the effectively enumerated dataset is organized by the category “Job Title” within a company. The dataset includes employees categorized by titles like “Software Engineer” and “Project Manager.” The technique 600 begins by loading this dataset into the entity resolution software. An incoming data record for “Jane Doe,” identified as a “Software Engineer,” is then received. The entity resolution software searches the dataset to find a potential match for “Jane Doe” based on her attributes. The entity resolution software checks if the “Job Title” category is associated with the incoming record. Upon confirming that it is, and assuming that only one “Jane Doe” is expected to be identified as a “Software Engineer” in the effectively enumerated dataset, the software associates the incoming record for “Jane Doe” with the matching entity in the dataset; otherwise, a new entity is created if no match is found.

For simplicity of explanation, the techniques 500 and 600 of FIGS. 5 and 6, respectively, are depicted and described as a series of blocks, steps, or operations. However, the blocks, steps, or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

As used herein, unless explicitly stated otherwise, any term specified in the singular may include its plural version. For example, “a computer that stores data and runs software,” may include a single computer that stores data and runs software or two computers – a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an application-specific integrated circuit (ASIC)), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving population statistics;
maintaining real-time statistics for attributes as records are processed;
receiving an incoming data record with attributes;
determining whether a category associated with the incoming data record has reached an enumeration threshold based on the population statistics;
determining an attribute importance of an attribute of the incoming data record based on a distinctiveness of the attribute within the category associated with the incoming data record, wherein the distinctiveness is determined based on the maintained real-time statistics for the attribute in response to determining that the category has reached the enumeration threshold; and
resolving the incoming data record to existing entities based on the attribute importance.

2. The method of claim 1, wherein the population statistics are organized according to hierarchical categories that include the category.

3. The method of claim 2, wherein for a hierarchical category of the hierarchical categories, a hierarchical level is independently assessed for whether the enumeration threshold has been reached.

4. The method of claim 2, wherein the population statistics include a total population count for each of the hierarchical categories.

5. The method of claim 1, wherein the enumeration threshold is determined based on a comparison between a number of identified entities and a total population count for the category provided by the population statistics.

6. The method of claim 1, wherein the attribute importance is dynamically adjusted by increasing a weight of the attribute if the attribute is distinctive within the category and the category has reached the enumeration threshold.

7. The method of claim 1, wherein resolving the incoming data record to the existing entities comprises:
determining a degree of similarity between the incoming data record and each existing entity;
calculating a match score for each existing entity based on the degree of similarity; and
associating the incoming data record with an existing entity having a match score exceeding a threshold.

8. The method of claim 1, further comprising:
creating a new entity associated with the incoming data record if no existing entity matches the incoming data record.

9. The method of claim 1, wherein maintaining the real-time statistics for the attributes within the categories further comprises:
updating attribute frequency counts for each category; and
re-evaluating enumeration thresholds based on the updated frequency counts.

10. The method of claim 1, wherein the enumeration threshold is configurable based on certainty requirements of an application.

11. The method of claim 1, further comprising:
progressively adjusting the attribute importance as population coverage increases toward the enumeration threshold.

12. The method of claim 1, wherein the enumeration threshold is expressed as at least one of: a percentage of known population, an absolute entity count, or a dynamically determined value based on statistical reliability.

13. A system, comprising:
a memory subsystem; and
processing circuitry, the processing circuitry configured to execute instructions stored in the memory subsystem to:
receive population statistics;
maintain real-time statistics for attributes as records are processed;
receive an incoming data record with attributes;
determine whether a category associated with the incoming data record has reached an enumeration threshold based on the population statistics;
determine an attribute importance of an attribute of the incoming data record based on a distinctiveness of the attribute within the category associated with the incoming data record, wherein the distinctiveness is determined based on the maintained real-time statistics for the attribute in response to determining that the category has reached the enumeration threshold; and
resolve the incoming data record to existing entities based on the attribute importance.

14. The system of claim 13, wherein the population statistics are organized according to hierarchical categories that include the category, and wherein for a hierarchical category of the hierarchical categories, a hierarchical level is independently assessed for whether the enumeration threshold has been reached.

15. The system of claim 13, wherein the attribute importance is dynamically adjusted by increasing a weight of the attribute if the attribute is distinctive within the category and the category has reached the enumeration threshold.

16. The system of claim 13, wherein, to maintain the real-time statistics for the attributes within the categories, the processing circuitry is configured to execute instructions stored in the memory subsystem to:
update attribute frequency counts for each category; and
re-evaluate enumeration thresholds based on the updated frequency counts.

17. One or more non-transitory computer-readable storage media, comprising executable instructions that, when executed by one or more processors, perform operations comprising:
receiving population statistics;
maintaining real-time statistics for attributes as records are processed;
receiving an incoming data record with attributes;
determining whether a category associated with the incoming data record has reached an enumeration threshold based on the population statistics;
determining an attribute importance of an attribute of the incoming data record based on a distinctiveness of the attribute within the category associated with the incoming data record, wherein the distinctiveness is determined based on the maintained real-time statistics for the attribute in response to determining that the category has reached the enumeration threshold; and
resolving the incoming data record to existing entities based on the attribute importance.

18. The one or more non-transitory computer-readable storage media of claim 17, wherein the population statistics are organized according to hierarchical categories that include the category, and wherein for a hierarchical category of the hierarchical categories, a hierarchical level is independently assessed for whether the enumeration threshold has been reached.

19. The one or more non-transitory computer-readable storage media of claim 17, wherein the attribute importance is dynamically adjusted by increasing a weight of the attribute if the attribute is distinctive within the category and the category has reached the enumeration threshold.

20. The one or more non-transitory computer-readable storage media of claim 17, wherein maintaining the real-time statistics for the attributes within the categories further comprises:
updating attribute frequency counts for each category; and
re-evaluating enumeration thresholds based on the updated frequency counts.
